(19) United States
(12) Patent Application Publication
(10) Pub. No.: US 2026/0269863 A1
(43) Pub. Date: Sep. 10, 2026

(54) METHOD AND APPARATUS FOR MANAGING DEVICE AND SERVICE ACCESS IN UWB SYSTEM

(71) Applicant: SAMSUNG ELECTRONICS CO., LTD., Suwon-si, Gyeonggi-do (KR)

(72) Inventors: Aniruddh Rao KABBINALE, Bangalore (IN); Karthik Srinivasa GOPALAN, Bangalore (IN); Ankur BANSAL, Bangalore (IN)

(21) Appl. No.: 19/165,990

(22) PCT Filed: Mar. 15, 2024
(86) PCT No.: PCT/KR2024/003295

§ 371 Date: Sep. 16, 2025

(30) Foreign Application Priority Data
Mar. 16, 2023 (IN) 202341017821
Sep. 13, 2023 (IN) 202341061709
Mar. 6, 2024 (IN) 202341017821

(51) Int. Cl. H04B 1/7163; H04W 12/63

(52) U.S. Cl. CPC H04B 1/7163; H04W 12/63

(57) ABSTRACT

The present disclosure relates to method and apparatus for managing device and service access and ZOIs in UWB System. A source UWB device is disclosed that serves as a key to unlock services on a target UWB device. The service is known/not known initially on the source UWB device. The method of the present disclosure provides service continuity through a service context transfer between the UWB devices. The method of the present disclosure includes creating multiple ZOIs in UWB based logical access, defining logical ZOIs and physical ZOIs, and transferring ZOI information over the wireless network and between one or more electronic devices.

### TECHNICAL FIELD

Embodiments disclosed herein relate to wireless communication networks, and more particularly to managing device and service access, and Zone Of Interests (ZOIs) in Ultra-Wideband (UWB) systems.

### BACKGROUND ART

In general, users need to access electronic devices manually to login to the electronic devices as well as services. From a user experience perspective, multiple actions are required to be performed by a user or an electronic device at different distance ranges between the electronic devices for logical access and maintenance of the access once granted.

In existing methods, in order to access devices and services, a user needs to manually login to the electronic device. Further, in order to access a service on the electronic device, the user needs to manually login to service again with service specific credentials, and the user manually performs actions to retain the granted access periodically.

Currently, a user using a service on a particular device and wanting to continue using that service on a second device needs to manually login to the second device and login to that particular service. In a case, where there are multiple devices on a local network or in vicinity, the user needs to manually find out a correct device to continue the service. Currently, there is no secure mechanism for the second device to authenticate using a first device to login onto the service.

Currently, there are no methods for seamless and secure login to devices, and uninterrupted services to the electronic devices, from an active electronic device. There is no mechanism for intuitive transfer of service context from one device to another device along with a user and service authentication.

Hence, there is a need in the art for solutions which will overcome the above mentioned drawback(s), among others.

### DISCLOSURE OF INVENTION

### Technical Problem

The principal object of embodiments herein is to disclose methods and systems for managing device and service access in Ultra-Wideband (UWB) Systems.

One of objects of embodiments herein is to disclose methods and systems where a first UWB device/mobile/smartphone serves as a key to unlock services on a target UWB device, wherein the service is known/not known initially on the first UWB device, and the service launches on the target UWB device (service triggered unlock).

One of objects of embodiments herein is to disclose methods and systems where a first UWB device/mobile/smartphone serves as a key to unlock services on a target UWB device, wherein the service is already known on the first UWB device, and the service launches on the target UWB device (service triggered unlock).

One of objects of the embodiments herein is to disclose methods and systems for detecting a specific user interaction pattern using UWB ranging and direction finding configure/record pattern, which can be detected during unlock/login, and logout/lock, and configuring specific patterns for specific devices when multiple devices are within the range.

One of objects of the embodiments herein is to disclose methods and systems for providing service continuity; i.e., transfer service context between one or more electronic devices.

One of objects of the embodiments herein is to disclose methods and systems for creating multiple Zone of Interests (ZOIs) in UWB based logical access.

One of objects of the embodiments herein is to disclose methods and systems for defining logical ZOIs and physical ZOIs.

One of objects of the embodiments herein is to disclose methods and systems for transferring ZOI information over the wireless network and within the electronic devices.

However, the effects obtainable from the present disclosure are not limited to those mentioned above, and other effects not mentioned can be clearly understood by those skilled in the art through the description provided below.

### Solution to Problem

Accordingly, the embodiments herein provide a method for managing access of at least one service in Ultra-Wideband (UWB) systems. The method comprises determining, by a source UWB device, whether the service on at least one target UWB device is known on the source UWB device. Thereafter, the method comprises unlocking, by the source UWB device, the service on the target UWB device, on determining that the service on the target UWB device is known on the source UWB device.

Accordingly, the embodiments herein provide a source UWB device. The source UWB device comprises a processor and a memory module. The processor is configured to determine whether at least one service on at least one target UWB device is known on the source UWB device. Further, the processor is configured to unlock the service on the target UWB device, on determining that the service on the target UWB device is known on the source UWB device.

Accordingly, the embodiments herein provide a source UWB device. The source UWB device comprises a processor and a memory module. The processor is configured to create a plurality of Zone Of Interests (ZOIs) where the plurality of ZOIs are configurable. The processor is configured to define one or more logical ZOIs and one or more physical ZOIs from the plurality of ZOIs. Further, the processor is configured to transfer information of the plurality of ZOIs between one or more UWB devices.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the following illustrative drawings. Embodiments herein are illustrated by way of examples in the accompanying drawings, and in which:

FIG. 1 illustrates a block representation of a system for managing access of at least one service in UWB systems, according to embodiments as disclosed herein;

FIG. 2 illustrates a method for managing access of at least one service in UWB systems, according to embodiments as disclosed herein;

FIG. 3 illustrates a method for launching at least one service on at least one target UWB device when service running on the target UWB device is known on the source UWB device, according to embodiments as disclosed herein;

FIG. 4 depicts a scenario for launching a service on a target UWB device, where the service is already known on the source UWB device, according to embodiments as disclosed herein;

FIG. 5 illustrates an alternate method for launching at least one service on at least one target UWB device when service running on the target UWB device is not known on the source UWB device, according to embodiments as disclosed herein;

FIG. 6 depicts a scenario for launching a service on a target UWB device, where the service is not known on the source UWB device, according to embodiments as disclosed herein;

FIG. 7 illustrates a method for transferring at least one service context of at least one service to two or more target UWB devices for service continuity, according to embodiments as disclosed herein;

FIG. 8 depicts a scenario for transferring a service context of a service to two or more target UWB devices for service continuity, according to embodiments as disclosed herein;

FIG. 9 illustrates a method for transferring at least one service context of at least one service from a first target UWB device to a second target UWB device for service continuity, according to embodiments as disclosed herein;

FIG. 10 depicts a scenario for transferring a service context of a service from a first target UWB device to a second target UWB device for service continuity, according to embodiments as disclosed herein;

FIG. 11 illustrates an example illustrating multiple spatial ZOIs, according to embodiments as disclosed herein;

FIG. 12 is a representation illustrating actions defined in the ZOI, according to embodiments as disclosed herein;

FIG. 13 illustrates a method of managing ZOIs using the ZOI configuration module, according to embodiments as disclosed herein;

FIG. 14 is a flow chart of a method for managing access of at least one service in UWB systems according to embodiments as disclosed herein; and

FIG. 15 is a flow chart of a method for managing access of at least one service in UWB systems according to embodiments as disclosed herein.

### BEST MODE FOR CARRYING OUT THE INVENTION

In one embodiment, a method performed by a source device for logical access in Ultra-Wideband (UWB) system is provided. The method comprising: identifying a presence of a target device in at least one zone of interest (ZOI), wherein the at least one ZOI is defined around the target device; and in case that the source device is within the at least one ZOI or transitioning into the at least one the ZOI, triggering a predetermined action related to the at least one ZOI.

In one embodiment, the method, wherein the predetermined action includes at least one of: unlocking the target device; locking the target device; launching a service on the target device; terminating a service on the target device; or sensing presence of the source device.

In one embodiment, the method, wherein the at least one ZOI includes one or more parameters related to shape or dimensions of the at least one ZOI.

In one embodiment, the method, wherein the at least one ZOI includes one or more parameters related to UWB ranging for the at least one ZOI.

In one embodiment, the method, further comprising: in case that the source device moves from a second ZOI from among the at least one ZOI to a first ZOI from among the at least one ZOI, triggering unlocking process or service terminating process on the target device,
in case that the source device moves from the second ZOI to a third ZOI from among the at least one ZOI, triggering locking process or service launching process on the target device; and
wherein the second ZOI is present to avoid repeated actions at boundary of the at least of ZOI.

In one embodiment, a source device, for logical access in Ultra-Wideband (UWB) system, is provided. The source device comprising: memory stored instructions; and at least one processor configure to execute the instructions to: identify a presence of a target device in at least one zone of interest (ZOI), wherein the at least one ZOI is defined around the target device, and in case that the source device is within the at least one ZOI or transitioning into the at least one the ZOI, trigger a predetermined action related to the at least one ZOI.

In one embodiment, the source device, wherein the predetermined action includes at least one of: unlocking the target device; locking the target device; launching a service on the target device; terminating a service on the target device; or sensing presence of the source device.

In one embodiment, the source device, wherein the at least one ZOI includes one or more parameters related to UWB ranging for the at least one ZOI.

In one embodiment, a method performed by a source device for logical access in Ultra-Wideband (UWB) system is provided. The method comprising: obtaining information on selecting a first target device and a service to be executed at the first target device; obtaining information for user authentication; based on proximity of the source device to the first target device, unlocking the first target device; and based on the information for user authentication, launching the service on the first target device by secure messaging between the source device and the first target device.

In one embodiment, the method, wherein the service is known on the source device.

In one embodiment, the method, further comprising: in case that the service is not known on the source device, fetching service list form the first target device; obtaining information on selecting the service among the fetched service list; and transmitting the information on selecting the service among the fetched service list, to the first target device.

In one embodiment, the method, further comprising: wherein in case that the service is running on the source device, transmitting information related to specific session of the service, to the first target device, based on the information for user authentication; launching the service on the first target device based on the information related to session of the service; and terminating the service running on the source device.

In one embodiment, the method, further comprising: in case that the service is running on the first target device, transmitting, to the first target device, request for session transfer information of the service; receiving, from the first target device, the session transfer information of the service; based on proximity of the source device to a second target device, unlocking the second target device; transmitting information related to session of the service, to the second target device, based on the session transfer information of the service; launching the service on the second target device based on the information related to session of the service; and terminating the service running on the first target device.

In one embodiment, a source device, for logical access in Ultra-Wideband (UWB) system, is provided. The source device comprising: memory stored instructions; and at least one processor configure to execute the instructions to: obtain information on selecting a first target device and a service to be executed at the first target device, obtain information for user authentication, based on proximity of the source device to the first target device, unlock the first target device, and based on the information for user authentication, launch the service on the first target device by secure messaging between the source device and the first target device.

In one embodiment, the source device, the at least one processor further configure to execute the instructions to: transmit information related to session of the service, to the first target device, based on the information for user authentication, launch the service on the first target device based on the information related to session of the service; and terminate the service running on the source device.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

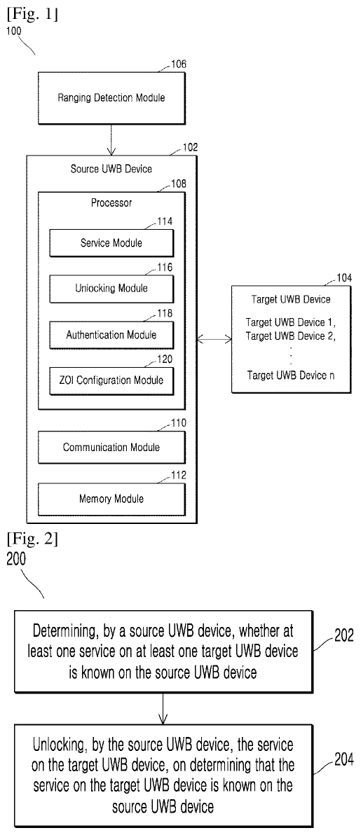

The embodiments herein provide methods and systems for managing device and service access in Ultra-Wideband (UWB) systems, and creating multiple Zone of Interests (ZOIs) in UWB based logical access. Referring now to the drawings, and more particularly to FIGS. 1 through 13, where similar reference characters denote corresponding features consistently throughout the figures, there are shown embodiments.

FIG. 1 illustrates a block representation of a system 100 for managing access of at least one service in UWB systems.

The system 100 comprises a source UWB device 102, at least one target UWB device 104 (target UWB device 1, target UWB device 2 . . . target UWB device n), and a Ranging detection module 106. The source UWB device 102 further comprises at least one processor 108, a communication module 110, and a memory module 112.

In an embodiment herein, the processor 108 can unlock one or more services on at least one target UWB device 104, wherein at least one service is known/not known initially on the source UWB device 102, and the service can be launched on the target UWB device 104 (service triggered unlock). Further, the processor 108 can create and define multiple ZOIs in UWB based logical access. The processor 108 can further comprise a service module 114, an unlocking module 116, an authentication module 118, and a ZOI configuration module 120.

In an embodiment herein, the service module 114 can be pre-configured with a list of services and corresponding one or more target UWB devices. The service module 114 can be configured with information of each service that runs on corresponding target UWB device 104. The service module 114 allows the unlocking module 116 to verify the list of services for verifying whether a service running on the target UWB device 104 is known on the source UWB device 102. The service module 114 can fetch a list of services running on the target UWB device 104 by exchanging one or more secured messages with the target UWB device 104, after authentication of the user. The service module 114 can enable the user to select a service from the list of services. The service module 114 can enable the user to select the target UWB device 104 from two or more target UWB devices by pointing, when the user likes to continue a particular service running on the source UWB device 102 to use on the target UWB device 104. The service module 114 can enable the user to select a second target UWB device from two or more target UWB devices by pointing, when the user likes to continue a particular service running on the first target UWB device to use on the second target UWB device.

In an embodiment herein, the unlocking module 116 can determine whether at least one service on at least one target UWB device 104 is known on the source UWB device 102. The unlocking module 116 can unlock the service on the target UWB device 104, on determining that the service on the target UWB device 104 is known on the source UWB device 102. The unlocking of the service on the target UWB device 104 can comprise at least one of launching the service automatically on the target UWB device 104, transferring at least one service context of the service to two or more target UWB devices 104 for service continuity, and transferring at least one service context of the service from a first target UWB device to a second target UWB device for service continuity. The service context of the service can be transferred using at least one of an in-band signalling and an out-of-band signalling.

In an embodiment herein, the unlocking module 116 can verify whether the service running on the target UWB device 104 is known on the source UWB device 102. The unlocking module 116 can verify a list of services which is pre-configured in the source UWB device 102, for verifying whether the service running on the target UWB device 104 is known on the source UWB device 102. The unlocking module 116 can enable a user to select the service on the source UWB device 102 for launching the service on the target UWB device 104, if the service running on the target UWB device 104 is known on the source UWB device 102. The unlocking module 116 can enable the user to select the service on the source UWB device 102 once the user authenticates to the source UWB device 102. The unlocking module 116 can trigger authentication of the user, and unlock the target UWB device 104, based on proximity of the user, once the user selects the service on the source UWB device 104. The unlocking module 116 can trigger automatic launch of the service on the target UWB device 104 by secure messaging between the source UWB device 102 and the target UWB device 104, after unlocking the at least one target UWB device 104.

In an embodiment herein, the unlocking module 116 can trigger automatic authentication of the user and unlock the target UWB device 104, based on proximity of the user, if the service running on the target UWB device 104 is not known on the source UWB device 102. The unlocking module 116 can trigger automatic authentication of the user, once the user authenticates to the source UWB device 102 and points to the target UWB device 104. The unlocking module 116 can receive a selection of a service from a list of services by the user. The unlocking module 116 can trigger the automatic launch of the selected service on the target UWB device 104 by secure messaging between the source UWB device 102 and the target UWB device 104.

In an embodiment herein, the unlocking module 116 can trigger the automatic authentication of the user and unlock the target UWB device 104, based on proximity of the user, once the user selects the target UWB device 104. The unlocking module 116 can trigger automatic launch of the service on the target UWB device 104 by secure messaging between the source UWB device 104 and the target UWB device 104, after automatic authentication. The unlocking module 116 can transfer the service context of the service from the source UWB device 102 to the target UWB device 104 for service continuity.

In an embodiment herein, the unlocking module 116 can fetch the service transfer context from the first target UWB device, once the user selects the second target UWB device. The unlocking module 116 can trigger automatic authentication of the user, and unlock the second target UWB device, based on proximity of the user, after fetching the service transfer context from the first target UWB device. The unlocking module 116 can trigger automatic launch of the service on the second target UWB device by secure messaging between the source UWB device 102 and the second target UWB device, after automatic authentication. The unlocking module 116 can transfer the fetched service context of the service from the source UWB device 102 to the target UWB device 104 for service continuity.

In an embodiment herein, the authentication module 118 can authenticate the user to the source UWB device 102. The authentication module 118 can automatically authenticate the user for the service that is launched on the target UWB device 104 or the second target UWB device.

In an embodiment herein, the selected service can be terminated on the source UWB device 102, when the service context is transferred to the target UWB device 104 or the second target UWB device.

In an embodiment herein, the ranging detection module 106 can detect a user action of pointing on the source UWB device 102 i.e., when the user points onto the source UWB device 102 for selecting at least one target UWB device 104 or the second target UWB device. The ranging detection module 106 can detect the user action of pointing on the source UWB device 102 using UWB ranging and direction measurements. The ranging detection module 106 may detect the user action with help of UWB ranging measurements done by source UWB device 102. For example, the user action of pointing on the source UWB device 102 is a user interaction pattern.

In an embodiment herein, the Zone Of Interest (ZOI) configuration module 120 can create a plurality of ZOIs. The ZOIs can be configurable. The ZOI configuration module 120 can define one or more logical ZOIs and one or more physical ZOIs from the plurality of ZOIs. The ZOI configuration module 120 can transfer information of the ZOIs between one or more UWB devices. The ZOI configuration module 120 can transfer information over the air and within the UWB device or an electronic device. The ZOI configuration module 120 can configure the ZOI in the vicinity of one or more electronic devices. The plurality of ZOIs can define one or more parameters. The parameters can be at least one of one or more spatial dimensions of the plurality of ZOIs, and one or more actions defined in the plurality of ZOIs. The spatial dimensions of the ZOIs can be, but not limited to, at least one of length, width, height, radius, and angle. The actions defined in the ZOIs can comprise at least one of determining a time interval for checking whether the presence of at least one UWB device within a ZOI is configurable, determining at least one action within a ZOI when the UWB device remains within the ZOI, and determining at least one action when the UWB device is transitioning between the ZOIs. In an embodiment herein, a configuration of the ZOI comprises at least one of a frequency of UWB ranging within the ZOI, a frequency of UWB sensing within the ZOI, a change of frequency of ranging within the ZOI with respect to time, and a change of frequency of sensing within the ZOI with respect to time. In an embodiment herein, the action when the UWB device is transitioning between the plurality of ZOIs, can comprise at least one of unlocking the UWB device, launching at least one service on the UWB device, locking the UWB device, terminating the service on the UWB device, and no action is performed.

In an embodiment herein, the processor 108 can process and execute data of a plurality of modules of the source UWB device 102. The processor 108 can be configured to execute instructions stored in the memory module 112. The processor 108 may comprise one or more of microprocessors, circuits, and other hardware configured for processing. The processor 108 can be at least one of a single processer, a plurality of processors, multiple homogeneous or heterogeneous cores, multiple Central Processing Units (CPUs) of different kinds, microcontrollers, special media, and other accelerators. The processor 108 may be an application processor (AP), a graphics-only processing unit (such as a graphics processing unit (GPU), a visual processing unit (VPU)), and/or an Artificial Intelligence (AI)-dedicated processor (such as a neural processing unit (NPU)).

In an embodiment herein, the plurality of modules of the processor 108 of the source UWB device 102 can communicate via the communication module 110. The communication module 110 may be in the form of either a wired network or a wireless communication network module. The wireless communication network may comprise, but not limited to, Global Positioning System (GPS), Global System for Mobile Communications (GSM), Wi-Fi, Bluetooth low energy, Near-field communication (NFC), and so on. The wireless communication may further comprise one or more of Bluetooth, ZigBee, a short-range wireless communication (such as Ultra-Wideband (UWB)), and a medium-range wireless communication (such as Wi-Fi) or a long-range wireless communication (such as 3G/4G/5G/6G and non-3GPP technologies or WiMAX), according to the usage environment.

The processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In an embodiment herein, the memory module 112 may comprise one or more volatile and non-volatile memory components which are capable of storing data and instructions of the modules of the source UWB device 102 to be executed. Examples of the memory module 112 can be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory module 112 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 112 may, in some examples, be considered a nontransitory storage medium. The term “non-transitory” may indicate that the storage medium is not embodied in a carrier wave or a propagated signal. However, the term “non-transitory” should not be interpreted to mean that the memory module 112 is nonmovable. In certain examples, a non-transitory storage medium may store data that can, over time, change (for example, in Random Access Memory (RAM) or cache).

FIG. 1 shows example modules of the source UWB device 102, but it is to be understood that other embodiments are not limited thereon. In other embodiments, the source UWB device 102 may include less or more number of modules. Further, the labels or names of the modules are used only for illustrative purpose and does not limit the scope of the invention. One or more modules can be combined together to perform same or substantially similar function in the source UWB device 102.

Therefore, embodiments herein disclose a source UWB device/mobile/smartphone as a key to unlock services on the target UWB device, wherein the service is known/not known initially on the source UWB device, and the service launches on the target UWB device (service triggered unlock). Embodiments herein enable service continuity, i.e., transfer service context between UWB devices. In an embodiment herein, service continuity can be offered across two devices, and service context can be transferred from a user's smartphone/source UWB device to a UWB target device (laptop, TV). In an embodiment herein, service continuity can be offered across three or more devices and the service context can be triggered from the UWB target device 1 (for example, laptop, TV), to the UWB target device 2 (for example, laptop, TV), using a user's smartphone/source UWB device. Embodiments herein disclose unlock as an example scenario, but it may be obvious to a person of ordinary skill in the art to apply locking/logout from service/device. The UWB data transfer steps as disclosed herein, can be in-band in UWB or out-of-band.

FIG. 2 illustrates a method 200 for managing access of at least one service in UWB systems.

The method 200 comprises determining, by the source UWB device 102, whether at least one service on at least one target UWB device 104 is known on the source UWB device 102, as depicted in step 202. Thereafter, the method 200 comprises unlocking, by the source UWB device 102, the service on the target UWB device 104, as depicted in step 204, on determining that the service on the target UWB device 104 is known on the source UWB device 102.

The various actions in method 200 may be performed in the order presented, in a different order or simultaneously. Further, in some embodiments, some actions listed in FIG. 2 may be omitted.

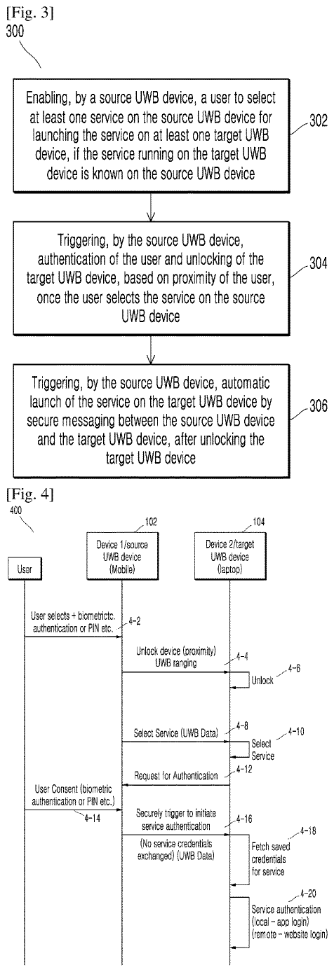

FIG. 3 illustrates a method 300 for launching at least one service on at least one target UWB device 104 when service running on the target UWB device 104 is known on the source UWB device 102.

The method 300 comprises enabling, by the source UWB device 102, a user to select at least one service on the source UWB device 102 for launching the service on the target UWB device 104, if the service running on the target UWB device 104 is known on the source UWB device 102, as depicted in step 302. The method 300 enables the user to select the service on the source UWB device 102, once the user authenticates to the source UWB device 102.

The method 300 comprises triggering, by the source UWB device 102, authentication of the user, and unlocking of the target UWB device 104, based on proximity of the user, as depicted in step 304, once the user selects the service on the source UWB device 102. Thereafter, the method 300 comprises triggering, by the source UWB device 102, automatic launch of the service on the target UWB device 104 by secure messaging between the source UWB device 102 and the target UWB device 104, as depicted in step 306, after unlocking the target UWB device 104.

The various actions in method 300 may be performed in the order presented, in a different order or simultaneously. Further, in some embodiments, some actions listed in FIG. 3 may be omitted.

FIG. 4 depicts a scenario 400 for launching a service on a target UWB device 104, where the service is already known on the source UWB device 102.

Consider that the service is already known on the source UWB device 102 (for example, smartphone)/service triggered unlock.

The user is provided with a UWB enabled smart phone/device 1 which allows the user to control and authenticate one or more target UWB devices and corresponding services running on the target UWB devices. The user selects the service (for example, streaming service) to be launched on the target UWB device/device 2 (for example, laptop, TV), as depicted in step 4-2, from the user's device (for example, smartphone). This automatically triggers authenticating the user and unlocking of the target UWB device 104, as depicted in steps 4-4 and 4-6, based on the proximity of user. This is followed by automatic triggering of the launch of the service on the target UWB device 104 by secure messaging between the smart phone/source UWB device 102 and the target UWB device 104, as depicted in steps 4-8, 4-10, and 4-12. Then, the user gets authenticated for the service that is launched, by the smartphone acting as an authenticator for the service, as depicted in steps 4-14 and 4-16. Thereafter, the target UWB device 104 fetches saved credentials for service, and provides service authentication (for example, through remote website login), as depicted in steps 4-18 and 4-20.

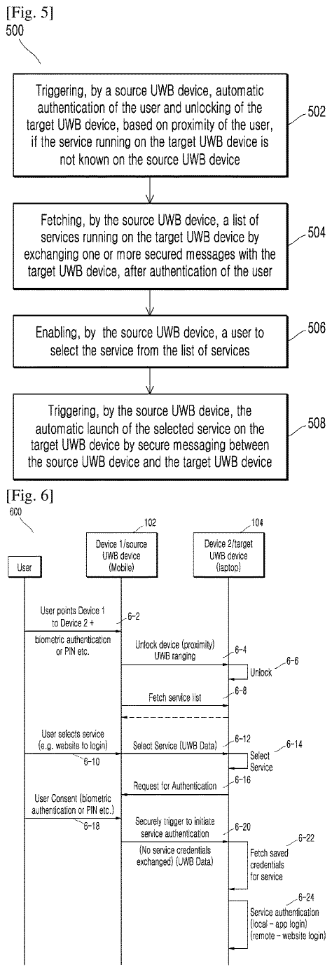

FIG. 5 illustrates an alternate method 500 for launching at least one service on at least one target UWB device 104 when service running on the target UWB device 104 is not known on the source UWB device 102.

The method 500 comprises triggering, by the source UWB device 102, automatic authentication of the user and unlocking of at least one target UWB device 104, based on proximity of the user, if at least one service running on the target UWB device 104 is not known on the source UWB device 102, as depicted in step 502. The source UWB device 102 authenticates and unlocks the target UWB device 104, once the user authenticates to the source UWB device 102, and points to the target UWB device 104.

The method 500 comprises fetching, by the source UWB device 102, a list of services running on the target UWB device 104 by exchanging one or more secured messages with the target UWB device 104, as depicted in step 504, after authentication of the user. Later, the method 500 comprises enabling, by the source UWB device 102, a user to select at least one service from the list of services, as depicted in step 506. Thereafter, the method 500 comprises triggering, by the source UWB device 102, the automatic launch of the selected service on the target UWB device 104 by secure messaging between the source UWB device 102 and the target UWB device 104, as depicted in step 508.

The various actions in method 500 may be performed in the order presented, in a different order or simultaneously. Further, in some embodiments, some actions listed in FIG. 5 may be omitted.

FIG. 6 depicts a scenario 600 for launching a service on a target UWB device 104, where the service is not known on the source UWB device 102.

In this scenario, consider that the service is not known initially on the source UWB device 102 (for example, smartphone).

The user is provided with a UWB enabled smart phone which allows the user to control and authenticate one or more target UWB devices, and services running on the target UWB devices, as depicted in step 6-2. This automatically triggers authenticating the user and unlocking of the target device, based on the proximity of user, as depicted in steps 6-4 and 6-6. This is followed by secure message exchange between smart phone and target device to fetch the list of services, as depicted in step 6-8. Later, the user selects a service that user wants to use, as depicted in step 6-10. This is followed by automatic triggering the launch of the service on the target UWB device 104 by secure messaging between the Smart phone/source UWB device 102 and target UWB device 104, as depicted in steps 6-12 and 6-14. Later, the user gets authenticated for the service that is launched, by smartphone acting as authenticator for service, as depicted in steps 6-16, 6-18, and 6-20. Thereafter, the target UWB device 104 fetches saved credentials for service, and provides service authentication (for example, through remote website login), as depicted in steps 6-22 and 6-24.

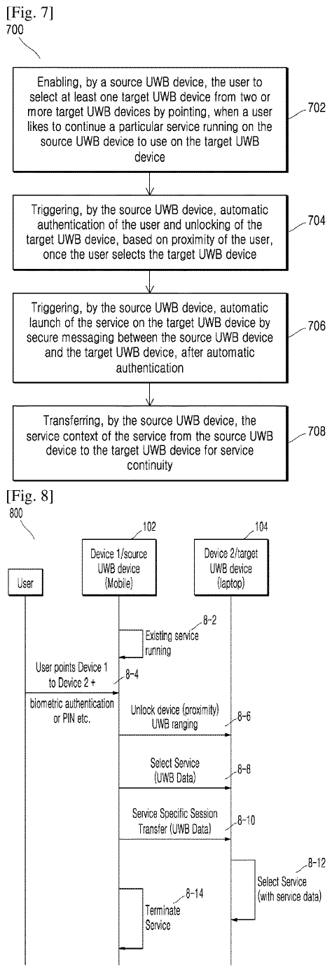

FIG. 7 illustrates a method 700 for transferring at least one service context of at least one service to two or more target UWB devices for service continuity.

The method 700 comprises enabling, by the source UWB device 102, the user to select at least one target UWB device 104 from two or more target UWB devices by pointing, as depicted in step 702, when the user likes to continue a particular service running on the source UWB device 102 to use on the target UWB device 104.

The method 700 comprises triggering, by the source UWB device 102, automatic authentication of the user and unlocking of the target UWB device 104, based on proximity of the user, as depicted in step 704. The source UWB device 102 authenticates and unlocks the target UWB device 104, once the user selects the target UWB device 104. The method 700 comprises triggering, by the source UWB device 102, automatic launch of the service on the target UWB device 104 by secure messaging between the source UWB device 102 and the target UWB device 104, as depicted in step 706, after automatic authentication. Thereafter, the method 700 comprises transferring, by the source UWB device 102, the service context of the service from the source UWB device 102 to the target UWB device 104 for service continuity, as depicted in step 708.

The various actions in method 700 may be performed in the order presented, in a different order or simultaneously. Further, in some embodiments, some actions listed in FIG. 7 may be omitted.

FIG. 8 depicts a scenario 800 for transferring a service context of a service to two or more target UWB devices for service continuity.

The service continuity can be offered across two devices, and service context can be transferred from a user's smartphone/source UWB device 102 to a target UWB device (laptop, TV) 104. The user is provided with an UWB enabled smartphone which allows to control and authenticate the target UWB devices and services running on the target UWB devices. The UWB enabled smartphone also runs the services (for example, streaming service).

For example, the user is running a particular service (for example, streaming service) on the smartphone/source UWB device 102, as depicted in step 8-2, and would like to continue using the service on the target UWB device 104. The user selects the target UWB device 104 (for example, by pointing), as depicted in step 8-4, wherein the pointing detection is done using UWB ranging and direction measurements. This automatically triggers authenticating the user and unlocking of the target UWB device 104, based on the proximity of user, as depicted in step 8-6. This is followed by automatically triggering the launch of the service on the target UWB device 104 by secure messaging between the Smart phone/source UWB device 102 and the target UWB device 104, as depicted in step 8-8. The user gets authenticated for the service that is launched, by the smartphone acting as authenticator for service. Later, the service transfer context is transferred from the source UWB device/smartphone 102 to the target UWB device 104, as depicted in steps 8-10 and 8-12. The service on the source UWB device/smartphone 102 is then terminated, as depicted in step 8-14.

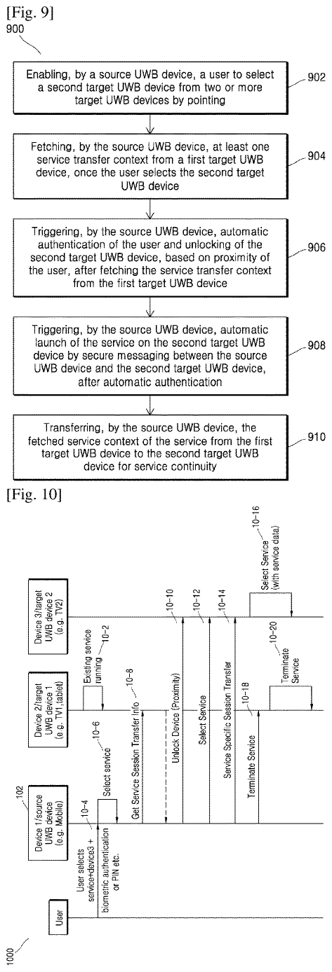

FIG. 9 illustrates a method 900 for transferring at least one service context of at least one service from a first target UWB device to a second target UWB device for service continuity.

The method 900 comprises enabling, by the source UWB device 102, the user to select the second target UWB device from two or more target UWB devices by pointing, as depicted in step 902. The source UWB device 102 enables the user to select the second target UWB device when the user likes to continue a particular service running on the first target UWB device to use on the second target UWB device.

The method 900 comprises fetching, by the source UWB device 102, at least one service transfer context from the first target UWB device, as depicted in step 904, once the user selects the second target UWB device. The method 900 comprises triggering, by the source UWB device 102, automatic authentication of the user and unlocking of the second target UWB device, as depicted in step 906, based on proximity of the user, after fetching the service transfer context from the first target UWB device.

Later, the method 900 comprises triggering, by the source UWB device 102, automatic launch of at least one service on the second target UWB device by secure messaging between the source UWB device 102 and the second target UWB device, as depicted in step 908, after automatic authentication. Thereafter, the method 900 comprises transferring, by the source UWB device 102, the fetched service context of the service from the first target UWB device to the second target UWB device for service continuity, as depicted in step 910.

The various actions in method 900 may be performed in the order presented, in a different order or simultaneously. Further, in some embodiments, some actions listed in FIG. 9 may be omitted.

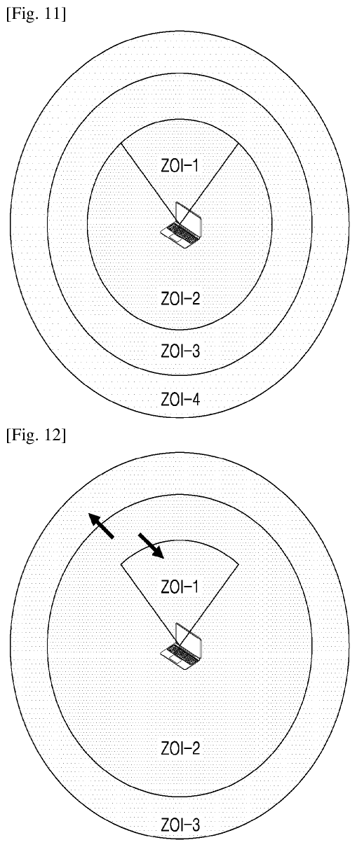

FIG. 10 depicts a scenario 1000 for transferring a service context of a service from a first target UWB device to a second target UWB device for service continuity.

The service continuity can be offered across 3+ devices, and the service context can be triggered from the first target UWB device/target UWB device 1 (e.g., TV1, tablet), to the second target UWB/target UWB device 2 (e.g., TV2), using a smartphone/source UWB device 102. The user has been provided with an UWB enabled smartphone which allows to control and authenticate the target UWB devices and services running on the target UWB devices.

For example, the user is running a particular service on the first target UWB device/target UWB device 1 (for example, streaming service), as depicted in step 10-2, and would like to continue using the service on the second target UWB device/target UWB device 2. The user selects the target UWB device 2 (for example, by pointing), as depicted in step 10-4, wherein the pointing detection is done using UWB ranging and direction measurements. The user selects the service through the source UWB device 102, as depicted in step 10-6. This automatically triggers fetching of the service transfer context from the target UWB device 1 in a secure manner, as depicted in step 10-8. This automatically triggers authenticating the user and unlocking of the target UWB device 2, based on the proximity of user, as depicted in step 10-10. This is followed by automatically triggering the launch of the service on the target UWB device 2 by secure messaging between the source UWB device 102 and the target UWB device 2. The user gets authenticated for the service that is launched, by the source UWB device 102 acting as authenticator for service, as depicted in step 10-12. The service transfer context is transferred from the source UWB device 102 to the target device UWB 2, as depicted in steps 10-14 and 10-16. Later, the service is terminated on the target UWB device 1, as depicted in steps 10-18 and 10-20.

In step 10-8, “Service Session Transfer Info” is information of the currently running service on the target UWB device 1, which may be used to setup session on the target UWB device 2. This information, “Service Session Transfer Info” may be processed by the source UWB device. The source UWB device then, in step 10-14, launches service on the target UWB device 2, by using “Service Specific Session Transfer”. “Service Specific Session Transfer” may include part of the information that was received form target UWB device 1, “Service Session Transfer Info”. “Service Specific Session Transfer” may also include other additional information required to launch the service on the target UWB device 2. In the present disclosure, “Service Session Transfer Info” refers to “session transfer information” and “Service Specific Session Transfer” refers to “information related to session of service”.

Embodiments herein disclose a specific user interaction pattern between a key/source UWB device/smartphone and a second device/target UWB device 104. This can be a combination of movement of the key device plus other inputs like biometric in a particular sequence. Specific user interaction patterns can be configured for various actions like lock device, unlock device. Also, the patterns can be different for specific devices. User interaction patterns are detected using UWB ranging and direction measurements between the key device and the second device. This can override or add to the mechanism in which devices are selected, in the mechanisms described.

In an embodiment herein, the Zone Of Interest (ZOI) configuration module 120 includes transferring ZOI information over the wireless environment within the UWB devices.

FIG. 11 illustrates an example illustrating multiple spatial ZOIs.

The spatial ZOI is defined by spatial dimensions such as length, width, height, radius, angle, and so on. The spatial ZOI can be defined in 1-dimensional area (1D), 2-Dimensional area (2D), 3-Dimensional area (3D), and so on. In an embodiment, at least one ZOI may be defined around the target UWB device 104. For example, one ZOI or a plurality ZOIs may be defined around the target UWB device 104.

Each ZOI can include a time dimension, to denote an amount of time after which an action is performed, after being in the ZOI. The ZOI can include other configurable parameters which determine when an action is triggered. The ZOI can be a physical ZOI or a logical ZOI. The physical ZOI can include spatial ZOI information and other dimensions such as time dimension. The configurable actions can be defined in the ZOIs. Logical ZOI is defined as ZOI that can occupy more than one physical ZOI, along with other dimensions/parameters. Multiple logical ZOIs can map to a same single physical ZOI. Logical ZOI is not constrained by physical dimensions. In an embodiment herein, one or more actions within the ZOI can be dependent on a user (even when a different logical ZOI maps to same physical ZOI). In another embodiment herein, one or more actions within the ZOI can be dependent on application (even when the different logical ZOI maps to the same single physical ZOI). FIG. 12 is a representation illustrating actions defined in the ZOI.

Using UWB ranging, the source UWB device 102 detects a presence of a target UWB device 104 in at least one ZOI and triggers a predefined action as the source UWB device 102 is within the at least one ZOI or transits into the at least one ZOI.

The actions defined in the ZOI can include but not limited to:
determining time interval for checking presence of an electronic device or a UWB device in ZOI is configurable.
frequency of UWB ranging within zone
frequency of UWB sensing within zone
change of frequency of ranging within zone with respect to time
change of frequency of sensing within zone with respect to time
   Action within zone
Action to be taken when the device remains within the zone
For example, lock the device while in this particular Zone of Interest after a given amount of time has elapsed.
   Action when transitioning between zones
Action to be taken when a device moves from one Zone of Interest to another Zone of Interest.
In one embodiment, as shown in the FIG. 12, following ZOI are defined: ZOI-1, ZOI-2, ZOI-3.
   When transitioning from ZOI-3 to ZOI 2=do nothing.
   When transitioning from ZOI-2 to ZOI 1=unlock the device/Launch a service.
   When transitioning from ZOI-1 to ZOI 2=do nothing.
   When transitioning from ZOI-2 to ZOI 3=lock the device/Terminate a service.

The ZOI information can be transferred between electronic devices (for example between laptop to mobile). The source UWB device 102 uses the information of the plurality of ZOIs to perform at least one of displaying a zone map to a user, and sending a notification to the user to remain active. The information can be used to allow the user to view the zone map. The ZOI configuration module 120 allows the user to decide how near to move to a target device, to initiate unlock/other actions. The information can be used to allow notification to user to remain active (Timeout information is provided as part of ZOI before system will lock). The information can include frequency information. For certain applications, a minimum frequency of ranging can be required to allow an action to complete.

Considering an example, the laptop can have at least 5 ranging measurements within 1 second, to allow unlock of an electronic device. In case, where the mobile phone is UWB controller (and thus determines the frequency of ranging), the frequency information can be required to be communicated from laptop to the mobile phone. The laptop, and mobile phone are used for illustration purpose, the electronic devices can be laptop, palmtop, mobile phone, smart devices, IoT devices, television, refrigerator, and so on.

Transfer of the ZOI information within the electronic device: ZOI information can be configured from higher layer within the electronic device to a lower layer using Application Programming Interface (APIs). The layers can reside within same or different hardware modules within the electronic device. For instance, the ZOI information can be configured from application, onto an independent framework or UWB subsystem allowing for some actions related to ZOI (such as change in frequency of ranging as defined by ZOI configuration) to happen automatically within lower layer without interrupting the application (higher layers). The ZOI information can be fetched from underlying layers.

Advertisement of ZOI information: some ZOI information can be advertised/broadcasted over the wireless network to nearby electronic devices. This may be especially helpful in certain use cases which pertain to use of public infrastructure.

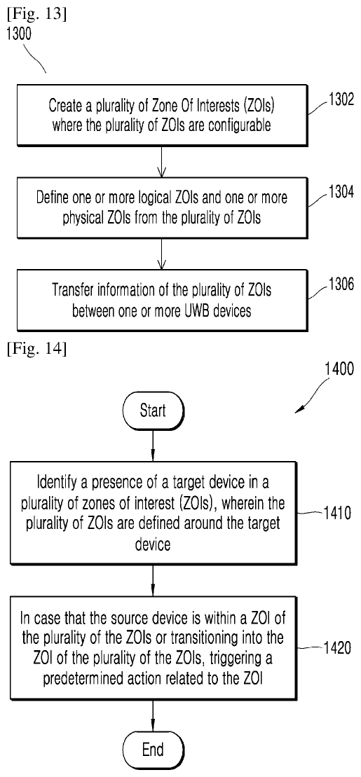

FIG. 13 illustrates a method 1300 of managing ZOIs using the ZOI configuration module 120. The method 1300 comprises creating, by the ZOI configuration module 120, a plurality of ZOIs, as depicted in step 1302, where the ZOIs are configurable. The method 1300 comprises defining, by the ZOI configuration module 120, one or more logical ZOIs and one or more physical ZOIs from the plurality of ZOIs, as depicted in step 1304. Thereafter, the method 1300 comprises transferring, by the ZOI configuration module 120, information of the ZOIs between one or more UWB devices, as depicted in step 1306.

The various actions in method 1300 may be performed in the order presented, in a different order or simultaneously. Further, in some embodiments, some actions listed in FIG. 13 may be omitted.

FIG. 14 is a flow chart a method 1400 for managing access of at least one service in UWB systems according to embodiments as disclosed herein.

Referring to FIG. 14, in step 1410, according to an embodiment, the source UWB device 102 may identify a presence of a target device in at least one zone of interest (ZOI). The at least one ZOI is defined around the target UWB device 104. In step 1420, in case that the source UWB device 102 is within the at least one ZOI or transitioning into the at least one the ZOI, the source UWB device 102 may trigger a predetermined action related to the at least one ZOI.

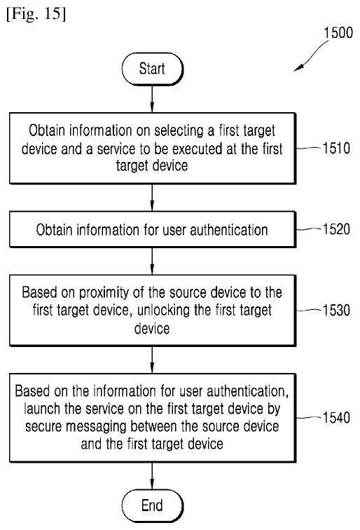

FIG. 15 is a flow chart a method 1500 for managing access of at least one service in UWB systems according to embodiments as disclosed herein.

Referring to FIG. 15, in step 1510, according to an embodiment, the source UWB device 102 may obtain information on selecting a first target UWB device and a service to be executed at the first target UWB device. In step 1520, the source UWB device 102 may obtain information for user authentication. In step 1520, based on proximity of the source UWB device 102 to the first target UWB device, the source UWB device 102 unlock the first target UWB device. In step 1530, based on the information for user authentication, the source UWB device 102 may launch the service on the first target UWB device by secure messaging between the source UWB device 102 and the first target UWB device.

The embodiments disclosed herein can be implemented through at least one software program running on at least one hardware device and performing network management functions to control the network elements. The modules shown in FIG. 1 include blocks which can be at least one of a hardware device, or a combination of hardware device and software module.

The embodiment disclosed herein describes methods (200, 300, 500, 700, 900, 1300), and systems 100 for managing device and service access in UWB systems, and creating multiple ZOIs in UWB based logical access. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

In addition, computer-readable storage media may be provided in the form of nontransitory storage media. The ‘non-transitory storage medium’ is a tangible device and only means that it does not contain a signal (e.g., electromagnetic waves). This term does not distinguish a case in which data is stored semi-permanently in a storage medium from a case in which data is temporarily stored. For example, the nontransitory recording medium may include a buffer in which data is temporarily stored.

The specific examples provided to explain the embodiments according to the present disclosure are merely a combination of each standard, method, detail method, and operation, and the various embodiments described herein can be performed through a combination of at least two or more techniques among the various techniques described. In addition, at this time, it can be performed according to a method determined through a combination of one or at least two or more of the aforementioned techniques. For example, it may be possible to perform a combination of parts of the operation of one embodiment with parts of the operation of another embodiment.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

1-15. (canceled)

16. A method, performed by a source device, for logical access in Ultra-Wideband (UWB) system, comprising:
identifying a presence of a target device, wherein space around the target device is divided into multiple zone of interests (ZOIs); and
based on a position of the source device, which is within at least one ZOI or transitioning into the at least one ZOI, triggering a defined action related to the at least one ZOI.

17. The method of claim 16, wherein the defined action includes at least one of:
unlocking the target device;
locking the target device;
launching a service on the target device;
terminating a service on the target device; or
sensing a presence of the source device.

18. The method of claim 16, wherein each ZOI of the multiple ZOIs has one or more parameters related to shape or dimensions of the each ZOI.

19. The method of claim 16, wherein each ZOI of the multiple ZOIs has one or more parameters related to UWB ranging for the each ZOI.

20. The method of claim 16, further comprising:
when the source device moves from a second ZOI among the multiple ZOIs to a first ZOI among the multiple ZOIs, triggering unlocking process or service terminating process on the target device; and
when the source device moves from the second ZOI among the multiple ZOIs to a third ZOI among the multiple ZOIs, triggering locking process or service launching process on the target device,
wherein the second ZOI is used to avoid constantly actions when the source device is at boundary of the multiple ZOIs.

21. A source device, for logical access in Ultra-Wideband (UWB) system, comprising:
at least one transceiver;
at least one processor communicatively coupled to the at least one transceiver; and
at least one memory, communicatively coupled to the at least one processor, storing instructions executable by the at least one processor individually or in any combination to cause the source device to:
identify a presence of a target device, wherein space around the target device is divided into multiple zone of interests (ZOIs), and
based on a position of the source device, which is within at least one ZOI or transitioning into the at least one ZOI, trigger a defined action related to the at least one ZOI.

22. The source device of claim 21, wherein the defined action includes at least one of:
unlocking the target device;
locking the target device;
launching a service on the target device;
terminating a service on the target device; or
sensing presence of the source device.

23. The source device of claim 21, wherein each ZOI has one or more parameters related to UWB ranging for the each ZOI.

24. The source device of claim 21, wherein each ZOI has one or more parameters related to shape or dimensions of the each ZOI.

25. The source device of claim 21, wherein the instructions further cause the source device to:
when the source device moves from a second ZOI among the multiple ZOIs to a first ZOI among the multiple ZOIs, trigger unlocking process or service terminating process on the target device; and
when the source device moves from the second ZOI among the multiple ZOIs to a third ZOI among the multiple ZOIs, trigger locking process or service launching process on the target device,
wherein the second ZOI is used to avoid constantly actions when the source device is at boundary of the multiple ZOIs.

26. A method, performed by a source device, for logical access in Ultra-Wideband (UWB) system, comprising:
obtaining information on selecting a first target device and a service to be executed at the first target device;
obtaining information for user authentication;
based on proximity of the source device to the first target device, unlocking the first target device; and
based on the information for user authentication, launching the service on the first target device by secure messaging between the source device and the first target device.

27. The method of claim 26, wherein the service is known on the source device.

28. The method of claim 26, further comprising, in case that the service is not known on the source device:
fetching a service list from the first target device;
obtaining information on selecting the service among the fetched service list; and
transmitting the information on selecting the service among the fetched service list, to the first target device.

29. The method of claim 26, further comprising, in case that the service is running on the source device:
transmitting information related to session of the service, to the first target device, based on the information for user authentication;
launching the service on the first target device based on the information related to session of the service; and
terminating the service running on the source device.

30. The method of claim 26, further comprising, in case that the service is running on the first target device:
transmitting, to the first target device, request for session transfer information of the service;
receiving, from the first target device, the session transfer information of the service;
based on proximity of the source device to a second target device, unlocking the second target device;
transmitting information related to session of the service, to the second target device, based on the session transfer information of the service;
launching the service on the second target device based on the information related to session of the service; and
terminating the service running on the first target device.

31. A source device, for logical access in Ultra-Wideband (UWB) system, comprising:
at least one transceiver;
at least one processor communicatively coupled to the at least one transceiver; and
at least one memory, communicatively coupled to the at least one processor, storing instructions executable by the at least one processor individually or in any combination to cause the source device to:
obtain information on selecting a first target device and a service to be executed at the first target device,
obtain information for user authentication,
based on proximity of the source device to the first target device, unlock the first target device, and
based on the information for user authentication, launch the service on the first target device by secure messaging between the source device and the first target device.

32. The source device of claim 31, wherein the service is known on the source device.

33. The source device of claim 31, wherein the instructions further cause the source device to, in case that the service is not known on the source device:
fetch a service list from the first target device;
obtain information on selecting the service among the fetched service list; and
transmit the information on selecting the service among the fetched service list, to the first target device.

34. The source device of claim 31, wherein the instructions further cause the source device to, in case that the service is running on the source device:
transmit information related to session of the service, to the first target device, based on the information for user authentication,
launch the service on the first target device based on the information related to session of the service, and
terminate the service running on the source device.

35. The source device of claim 31, wherein the instructions further cause the source device to, in case that the service is running on the first target device:
transmit, to the first target device, request for session transfer information of the service;
receive, from the first target device, the session transfer information of the service;
based on proximity of the source device to a second target device, unlock the second target device;
transmit information related to session of the service, to the second target device, based on the session transfer information of the service;
launch the service on the second target device based on the information related to session of the service; and
terminate the service running on the first target device.
